(19) United States
(12) Patent Application Publication
(10) Pub. No.: US 2025/0161802 A1
(43) Pub. Date: May 22, 2025

(54) SYSTEMS AND METHODS FOR WAVEFORM REPRODUCTION ON LINEAR HAPTIC DEVICES

(71) Applicant: Microsoft Technology Licensing, LLC, Redmond, WA (US)

(72) Inventors: Nicholas John Vernon THOMPSON, Sammamish, WA (US); Alexander Robert Paul GRENIER, Seattle, WA (US); Beau Willis CRAWFORD, Willow, AK (US)

(21) Appl. No.: 18/511,358

(22) Filed: Nov. 16, 2023

(51) Int. Cl. A63F 13/285; G06F 3/01; H04R 3/04

(52) U.S. Cl. CPC A63F 13/285; G06F 3/016; H04R 3/04

(57) ABSTRACT

A device may obtain a provided haptic waveform. A device may identify vibrational information of the provided haptic waveform in a crossover network. A device may identify audio information of the provided haptic waveform in the crossover network. A device may attenuate at least a portion of the audio information to create attenuated audio information. A device may remix the vibrational information and the attenuated audio information in an output haptic waveform. A device may drive a linear haptic device at least partially according to the output haptic waveform.

### BACKGROUND

### Background and Relevant Art

Electronic device controllers allow users to provide directional and button inputs to a video game console or other computing device. Joysticks, thumbsticks, and other directional input sticks can allow for analog or digital directional inputs with the electronic device controller. Face buttons, directional input pads, and triggers can allow for digital or analog user inputs. The electronic device controller can also provide haptic feedback to the user during or independently of user inputs to the electronic device controller. As the controller often replicates holding an in-software mechanism or object, haptic feedback can increase the immersion perceived by the user.

### BRIEF SUMMARY

In some aspects, the techniques described herein relate to a method of providing haptic feedback to a user, the method including: obtaining a provided haptic waveform; identifying vibrational information of the provided haptic waveform in a crossover network; identifying audio information of the provided haptic waveform in the crossover network; attenuating at least a portion of the audio information to create attenuated audio information; remixing the vibrational information and the attenuated audio information in an output haptic waveform; and driving a linear haptic device at least partially according to the output haptic waveform.

In some aspects, the techniques described herein relate to a method of providing haptic feedback to a user, the method including: determining a provided haptic waveform from software audio information; identifying vibrational information of the provided haptic waveform in a crossover network; identifying audio information of the provided haptic waveform in the crossover network; attenuating at least a portion of the audio information to create attenuated audio information; remixing the vibrational information and the attenuated audio information in an output haptic waveform; and driving a linear haptic device at least partially according to the output haptic waveform.

In some aspects, the techniques described herein relate to a device for providing haptic feedback to a user, the device including: a haptic controller; a linear haptic device; a processor; and a hardware storage device, the hardware storage device having instructions stored thereon that, when executed by the processor, cause the device to: obtain a provided haptic waveform; identify vibrational information of the provided haptic waveform in a crossover network; identify audio information of the provided haptic waveform in the crossover network; attenuate at least a portion of the audio information to create attenuated audio information; remix the vibrational information and the attenuated audio information in an output haptic waveform; and drive a linear haptic device at least partially according to the output haptic waveform.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1-1 is a top view of an electronic device controller, according to at least some embodiments of the present disclosure.

FIG. 1-2 is a side perspective view of the electronic device controller of FIG. 1-1.

FIG. 2-1 is a front view of an electronic device controller with haptic regions, according to at least some embodiments of the present disclosure.

FIG. 2-2 is a side view of the electronic device controller of FIG. 2-1.

FIG. 3-1 through FIG. 3-4 illustrates the movement of a mass within a linear haptic device, according to at least some embodiments of the present disclosure.

FIG. 4 is a perspective view of an embodiment of an eccentric rotating mass ERM haptic device, according to at least some embodiments of the present disclosure.

FIG. 5-1 is a provided haptic waveform, according to at least some embodiments of the present disclosure.

FIG. 5-2 is a converted haptic waveform of the provided haptic waveform of FIG. 5-1, according to at least some embodiments of the present disclosure.

FIG. 6-1 is a provided haptic waveform, according to at least some embodiments of the present disclosure.

FIG. 6-2 is a converted haptic waveform of the provided haptic waveform of FIG. 6-1, according to at least some embodiments of the present disclosure.

FIG. 7 is a schematic diagram of an electronic device controller, according to at least some embodiments of the present disclosure.

FIG. 8 is a crossover network by frequency, according to at least some embodiments of the present disclosure.

FIG. 9 is a system diagram of an electronic device controller in communication with an electronic device, according to at least some embodiments of the present disclosure.

FIG. 10 is a flowchart illustrating a method of providing haptic feedback to a user, according to at least some embodiments of the present disclosure.

FIG. 11 is a flowchart of an ML model that may be used with any of the methods described herein, according to at least some embodiments of the present disclosure.

### DETAILED DESCRIPTION

The present disclosure relates generally to systems and methods for providing haptic feedback to a user with a haptic device. More particularly, the haptic devices described herein are configured to provide haptic feedback to a user based on haptic information from a local computing device, remote computing system (cloud/internet), or a specialized video game console. In some embodiments, a haptic device according to the present disclosure is part of an electronic device controller that may be in data communication with an electronic device, such as a personal computer, cloud service, or video game console. In some embodiments, an electronic device controller is in data communication via a wired data connection. In other embodiments, the electronic device controller is in wireless data communication. In some embodiments, a haptic device, according to the present disclosure, is part of another electronic device, such as an article of furniture, a wearable device, or another electronic device that is not a controller.

In some embodiments, a haptic device, according to the present disclosure, is a linear haptic device. For example, a linear haptic device is any haptic device configured to accelerate a mass in a linear motion. The linear haptic device may oscillate the mass within a housing to create a shaking sensation. The linear haptic device may accelerate the mass once to create a click sensation. In some examples, a linear haptic device includes any of a linear resonant actuator (LRA), voice coil actuator (VCA), piezo electric actuators (PEA), and other electromagnetic actuators or motor that accelerate a mass with a linear acceleration. The duration, amplitude, and frequency of the waveform produced by the acceleration and/or oscillation of the mass in the haptic device can simulate or suggest a variety of haptic feedbacks to a user.

In some embodiments, the haptic device is used to simulate a haptic event, such as an in-software event, experience, action, or object. For example, the electronic device controller may be a user input device to a computing device or electronic gaming console. The computing device or electronic gaming console may have an interactive software application stored thereon that, when executed by the computing device or electronic gaming console, simulates a virtual environment with which the user can interact. When an avatar or other user-proxy interacts with the virtual environment, haptic feedback through the electronic device controller may convey that haptic event to the user. While the present disclosure will primarily reference virtual environments, in other examples, the electronic device controller may be a user input device to a machine or other device that moves and interacts with the physical environment. The electronic device controller may control or operate at least a portion of the machine, and when the machine interacts with the physical environment, haptic feedback through the electronic device controller may convey that haptic event to the user. In other examples, the haptic device is part of another device, such as an article of furniture that provides haptic feedback to the user.

In some embodiments, a haptic device, according to the present disclosure, is an eccentric rotating mass (ERM) haptic device. For example, the ERM haptic device has a motor that rotates a rotationally imbalanced mass around a rotational axis to create a vibration at a frequency based at least partially rotational frequency. In some examples, the motor of the ERM haptic device rotates the mass at an angular velocity and frequency based at least partially on a voltage applied to the motor.

In a particular example, the electronic device controller may allow the user to operate a power drill (either virtual or physical). In some embodiments, the haptic device may simulate the haptic event of the vibrations of drilling into a plank of wood by recreating the haptic event via haptic devices at the same frequency, the same duration, the same amplitude, or combinations thereof. For example, a drill may vibrate at a frequency of 100 Hertz (Hz) in the virtual environment, and the haptic device may recreate that haptic event with haptic feedback of 100 Hz at the haptic device. The frequency of the haptic event provides a recognizable sensation that, while hearing the drill and seeing a visualization of the drill on a display device, causes the user to perceive the haptic feedback through the electronic device as correlating to the haptic event displayed.

In some embodiments, the haptic device emits an audible vibration that recreates audio information in a provided haptic waveform. While the power drill of the above example vibrates at 100 Hz or less, a whine of an electric motor of the drill can be reproduced by the haptic device or a second haptic device at approximately 2000 Hz. In some embodiments, the higher frequency audio information reproduced by the haptic device is not perceptible to the user in a tactile manner, but the additional audio reproduction can increase immersion or provide an additional channel of audio for a software developer.

In some examples, the electronic device (a computing device, a physical machine, or other device) that generates the haptic event may provide a haptic waveform to be replicated at the haptic device. In some embodiments, the haptic waveform is intended for a linear haptic device and includes a plurality of overlaid sinusoidal waveforms that combine to create the provided haptic waveform. In such embodiments, the haptic waveform is replicable by the response rate of a linear haptic device.

In some embodiments, systems and methods according to the present disclosure convert the provided haptic waveform to one or more frequency peaks, which can be individually remixed into a remixed haptic waveform for reproduction at one or more haptic devices. In some embodiments, a crossover network separates a provided haptic waveform into vibrational information and audio information based at least partially on a crossover value between the vibrational information and audio information portions of the provided haptic waveform. In some embodiments, the vibrational information of the provided haptic waveform is reproduced at or near a resonant frequency of the haptic device, conserving electrical power in the accessory device. In some embodiments, the audio information of the provided haptic waveform is attenuated or otherwise reduced in amplitude. For example, the audio information may be a higher frequency than the vibrational information and consume more power to reproduce with the haptic device than the vibrational information. Attenuating an amplitude of the audio information before producing the haptic feedback can allow the haptic device to provide the intended haptic feedback of the vibrational information while remaining within power limitations of the accessory device and/or haptic device.

In some embodiments, a Fourier transform converts the provided haptic waveform from an amplitude-versus-time waveform into an amplitude-versus-frequency converted waveform. The frequency peaks in the converted waveform above a crossover value are identified as audio information, and the frequency peaks in the converted waveform below the crossover value are identified as vibrational information.

The audio information above the crossover value is attenuated to limit power consumption before the vibrational information and attenuated audio information are remixed into an output haptic waveform. In some embodiments, the output haptic waveform is used to drive a linear haptic device, a plurality of linear haptic devices, or a linear haptic device and an ERM haptic device.

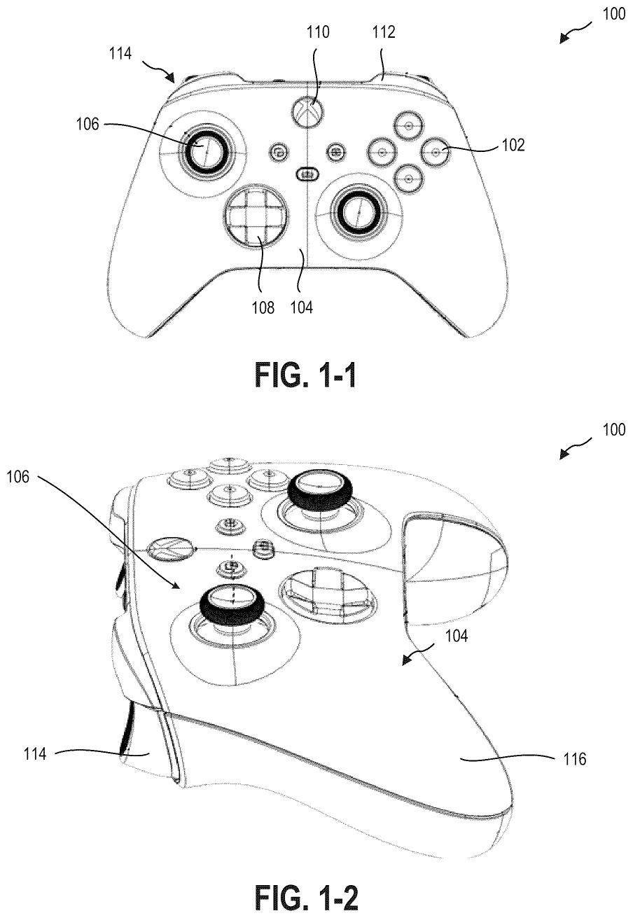

Referring now to FIG. 1, in some embodiments, an electronic device controller 100 includes a plurality of input buttons located on or in a body 104 of the electronic device controller 100 with at least one directional input device. The directional input devices may include one or more analog thumbsticks 106 and/or one or more directional control pads 108. The input buttons may include face buttons 102, one or more menu or system buttons 110, shoulder buttons 112, trigger buttons 114, rear paddles, etc.

The thumbsticks 106 and/or directional control pads 108 may be used to control the movement of an avatar or cursor in a two-or three-dimensional virtual environment. The input buttons may be used to provide action commands (e.g., jump, crouch, defend, attack) to an avatar and/or interact with the environment. For example, a face button 102 may be used to provide a jump command to an avatar in an adventure game application, while an analog trigger button 114 may allow a user to precisely modulate a brake input for a racing game application.

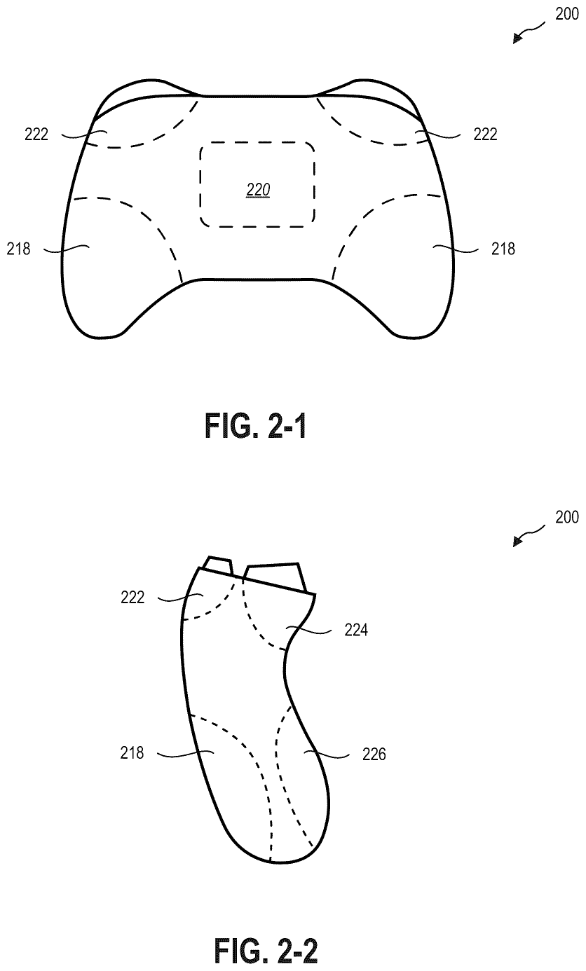

FIG. 1-2 is a side perspective view of the electronic device controller 100 of FIG. 1-1. The electronic device controller 100 may include one or more haptic devices located in the body 104. In some embodiments, the haptic device imparts haptic feedback to the surface of the body 104, such as on a grip 116 of the body 104, through which the user's palm may experience the haptic feedback. In some embodiments, haptic device imparts haptic feedback to a directional input device, such as a thumbstick 106, or to an input button, such as a trigger button 114. In at least one embodiment, a haptic device in or in communication with the trigger button 114 may convey haptic events, such as changes in road surface during braking in the prior example. An electronic device controller 100 may include a plurality of haptic devices in different locations, orientations, and configurations to provide a variety of haptic feedback to the user.

FIG. 2-1 is a schematic representation of an embodiment of haptic regions of an electronic device controller 200. FIG. 2-2 is a side view of the electronic device controller of FIG. 2-1 with additional haptic regions. FIG. 2-1 is a front view of an electronic device control 200 without directional input devices or face buttons for ease of viewing the designated haptic regions. In some embodiments, an electronic device controller 200 includes front grip regions 218, a main body region 220, shoulder regions 222, trigger regions 224, rear grip regions 226, other haptic regions, or combinations thereof. In some embodiments, an electronic device controller 200 includes haptic devices in or in communication with directional input devices and/or input buttons, as described herein.

The haptic regions of the electronic device controller 200 may provide haptic feedback to different regions of the user's hands and simulate or suggest different types of haptic events. For example, haptic feedback in the front grip regions 218 may alternate between a left front grip region 218 and a right front grip region 218 to simulate or suggest footsteps in a virtual environment. Longer duration haptic feedback on the front grip regions 218 may indicate footsteps from a larger entity or avatar, such as an elephant, in the virtual environment. In some examples, haptic feedback in the shoulder regions 222 (located on the top edge of the body 204) may simulate or suggest rain falling on the user's avatar. In some examples, haptic feedback in the main body region 220 may indicate a generalized or global haptic event, such as an explosion or earthquake in the virtual environment.

In some embodiments, different haptic devices are located in different haptic regions of the electronic device controller 200, such as different resonant frequencies, different amplitudes, different orientations, or different configurations between the haptic regions. In some embodiments, the electronic device controller 200 includes an ERM haptic device. In some embodiments, the electronic device controller 200 includes a linear haptic device. In some embodiments, the electronic device controller 200 includes a plurality of haptic devices. In some embodiments, the electronic device controller 200 includes a plurality of haptic devices that includes at least one ERM haptic device and at least one linear haptic device.

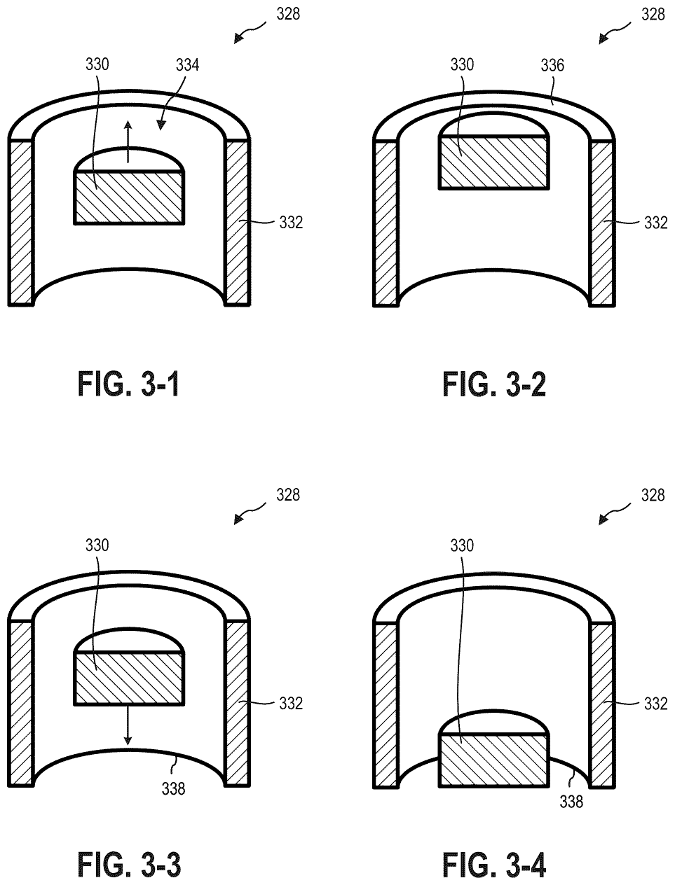

A linear haptic device may have a resonant frequency at which the linear haptic device is most efficient. Replication of high amplitude waveforms with a frequency at or near the resonant frequency may be the most power efficient haptic feedback the linear haptic device can produce. For example, FIG. 3-1 through 3-4 are side cross-sectional views of a linear haptic device with an oscillating mass therein. FIG. 3-1 is a side cross-sectional view of a linear haptic device 328. The linear haptic device 328 moves a mass 330 to generate impulses that provide the haptic feedback. In some embodiments, an electromagnet 332 generates a magnetic field in a bore 334 of the linear haptic device 328. The mass 330 experiences a magnetic force in response to the presence of the magnetic field accelerating the mass 330 in a first direction in the bore 334.

The electromagnet may then change a direction of the magnetic field and apply a magnetic force in the opposite direction. FIG. 3-2 illustrates the mass 330 reaching a first end 336 of the electromagnet 332 before slowing and stopping proximate the first end 336 due to a restoring force. In some embodiments, a magnetic biasing element, such as a permanent magnet, applies the restoring force. In some embodiments, a mechanical biasing element, such as a spring or a bushing, applies the restoring force. After stopping proximate the first end 336, the mass 330, in some embodiments, accelerates away from the first end 336 toward a center of the bore 334.

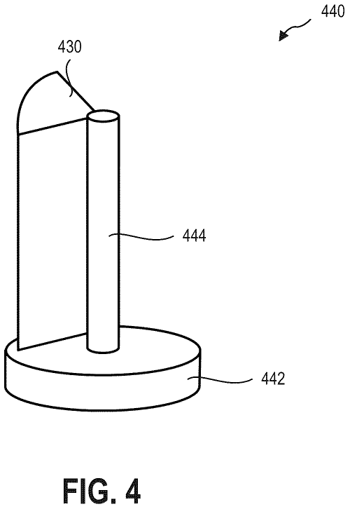

FIG. 3-3 illustrates the mass 330 passing through the center of the bore 334 with an impulse applied to the mass 330 to accelerate the mass 330 through the bore 334. The mass 330 moves through the bore 334 toward a second end 338 of the bore 334, as shown in FIG. 3-4. By oscillating through the bore 334, the mass 330 shakes the linear haptic device 328 to create haptic feedback in response to an applied electric current in the direction of the oscillating mass 330. The magnetic field generated by the electromagnet 332 may determine the speed, frequency, and amplitude of the oscillations through the linear haptic device 328.

FIG. 4 is a perspective view of an embodiment of an eccentric rotating mass ERM haptic device 440. The ERM haptic device 440 provides low frequency, slow response haptics. The ERM haptic device 440 includes a motor 442 configured to rotate a driveshaft 444. The driveshaft 444 is rotationally fixed to a mass 430. The rotating mass 430 is off-center from the rotational axis of the driveshaft 444.

ERM haptic devices produce an uneven centripetal force which causes the ERM haptic device to move in a lateral direction relative to the rotational axis of the driveshaft 444. This movement also produces associated lateral vibrations. ERM haptic devices typically contain a larger mass than a linear haptic device, which allows for more powerful haptic feedback, but with lower frequency and with slower latency. In contrast, linear haptic devices can allow for rapid changes to amplitude that can modulate the haptic feedback and/or start and stop the haptic feedback faster than an ERM. In some embodiments, an ERM haptic device can be used in conjunction with a linear haptic device to provide a combination of powerful and advanced haptic feedback.

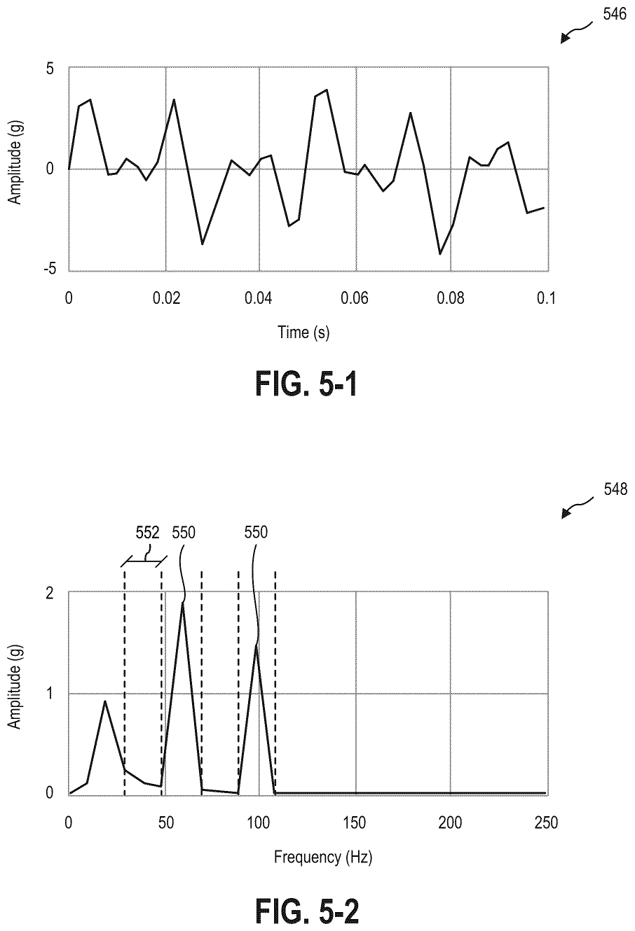

FIG. 5-1 is an embodiment of a provided haptic waveform 546 intended for a linear haptic device. The provided haptic waveform 546 is, in some embodiments, non-sinusoidal with a plurality of frequencies present in the provided haptic waveform 546. The shorter latency of a linear haptic device may allow the linear haptic device to replicate the provided haptic waveform 546, while the longer latency of an ERM haptic device allows the ERM haptic device to replicate the primary or secondary vibrational frequencies of the provided haptic waveform 546.

In some embodiments, the provided haptic waveform 546 is converted to a converted waveform by a Fourier transform. In some embodiments, the Fourier transform is a complete Fourier transform. In some embodiments, the Fourier transform is a discrete Fourier transform (DFT). In some embodiments, the Fourier transform is a fast Fourier transform (FFT). The Fourier transform converts the amplitude-versus-time waveform of the provided haptic waveform 546 to an amplitude-versus-frequency waveform of the converted haptic waveform 548, as illustrated in FIG. 5-2.

FIG. 5-2 is the converted haptic waveform 548 after an FFT. The converted haptic waveform 548 decomposes the provided haptic waveform 546 to a set of sinusoidal waveforms that are represented at frequency peaks 550 within the converted haptic waveform 548. The higher the amplitude of the frequency peak 550, the greater the amplitude of the associated sinusoidal wave component of the provided haptic waveform 546. The converted haptic waveform 546 can, thereby, decompose the provided haptic waveform 546 into the portions (e.g., constituent sinusoidal waveforms) with frequencies above a crossover value and below the crossover value in a crossover network.

The precision with which a frequency peak 550 can be determined, however, is relative to the width of a frequency bin 552 of the converted haptic waveform 548. The width of the frequency bin 552 is related to the sample length of the provided haptic waveform 546. In some embodiments, systems and methods according to the present disclosure sample the provided haptic waveform 546 based at least partially on a buffer duration. In some embodiments, the buffer duration is in a range having an upper value, a lower value, or upper and lower values including any of 10 milliseconds (ms), 20 ms, 30 ms, 50 ms, 100 ms, 200 ms, 500 ms, or other durations. For example, the provided haptic waveform 546 of FIG. 5-1 has a length of 100 ms. After the FFT conversion to the converted haptic waveform 548 of FIG. 5-2, the frequency bins 552 have a frequency bin width of 20 Hertz.

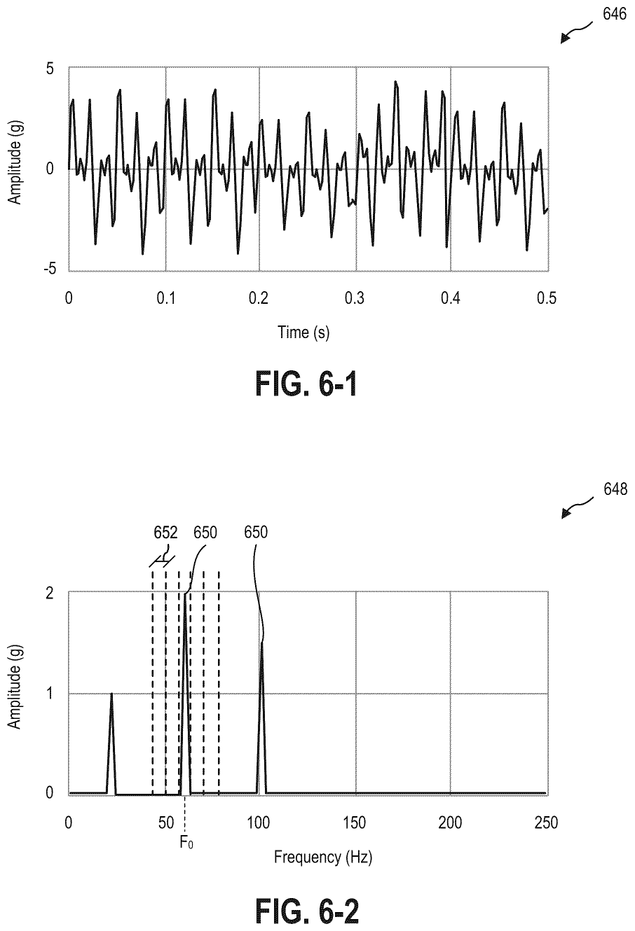

In contrast, the provided haptic waveform 646 of FIG. 6-1 is the same waveform with a length of 500 ms. After the FFT conversion to the converted haptic waveform 648 of FIG. 6-2, the frequency bins 652 are approximately 8 Hertz, as illustrated in FIG. 6-2. The longer sample in the provided haptic waveform 646 allows greater precision in the identification of the frequency peaks 650 of the converted haptic waveform 648 and more accurate reproduction of the components of the provided haptic waveform 646 by the haptic device(s).

As described above, in some embodiments, the provided haptic waveform 646 is provided from the electronic device based on an expected linear haptic device. For example, the developer of an interactive software application (e.g., a video game) for the electronic device (e.g., video game console) may provide, through an API, the provided haptic waveform 646 based on the linear haptic device provided in an electronic game controller that is common for or standard with that electronic device. linear haptic device has an inherent resonant frequency (F₀) of the mass in the linear haptic device based upon the properties of the mass, magnet(s), materials, other components, manufacturing tolerances, etc. A single linear haptic device may exhibit variations in the natural resonant frequency based at least partially on age or wear of the linear haptic device, temperature of the linear haptic device, orientation of the linear haptic device, etc. In some embodiments, systems and methods according to the present disclosure calculate or measure the dynamic resonant frequency of the haptic device to adapt the drive frequency of the magnetic field to the dynamic resonant frequency.

A linear haptic device, such as an LRA or VCA, has a natural resonant frequency at which the harmonics of the linear haptic device allow the linear haptic device to continue oscillating with the least input energy. For example, an impulse that is timed at the natural resonant frequency of the mass through the bore of the linear haptic device accelerates the mass through bore with the energy loss. Similar to a pendulum motion, the mass experiences a restoring force that urges the mass back toward the center of the bore (such as illustrated in FIG. 3-3). The impulse applied to the mass can maintain or change the amplitude of the oscillation of the mass.

In some embodiments, an output haptic waveform is output by a haptics controller to the haptic device as a series of electrical signals to control the electromagnet of the linear haptic device. The output haptic waveform is generated at the linear haptic device by providing input energy to a mass via the magnetic field generated in response to the electrical signals. By applying a magnetic force to the mass at the resonant frequency in alternating directions as the mass oscillates, the mass is moved with the least input energy and least power consumption. More specifically, some embodiments apply the magnetic force while the mass is near the center of the bore and while the net restoring force (i.e., that applied near either end of the bore) is approximately zero. As the restoring force may be a permanent magnet or a mechanical biasing element, the restoring force of the linear haptic device requires little or no input energy. To cause the mass to oscillate at a frequency other than the resonant frequency, additional input energy is needed to overcome or add to the restoring force.

Oscillations at or near the resonant frequency, therefore, can produce large vibration amplitudes with comparatively less input energy, while other frequencies (such as audio information at higher frequencies) can require greater input energy. In some embodiments, as will be described more herein, a crossover value of the crossover network for the haptic waveform is selected at least partially based on the resonant frequency of the linear haptic device.

In some embodiments, the provided haptic waveform is provided and/or selected at least partially based on the resonant frequency of the expected linear haptic device. When the provided haptic waveform (e.g., provided haptic waveforms 546, 646) is converted to a converted haptic waveform (e.g., converted haptic waveforms 548, 648) by a Fourier transform, the resonant frequency of the expected linear haptic device may manifest as a frequency peak. However, the unique haptic information of the provided haptic waveform may be presented in the other frequency peaks, and some embodiments of systems and methods according to the present disclosure discount, reduce, or ignore the frequency peak at the resonant frequency of the expected linear haptic device as that frequency peak may be present in some, most, or all of the provided haptic waveforms intended for the expected linear haptic device.

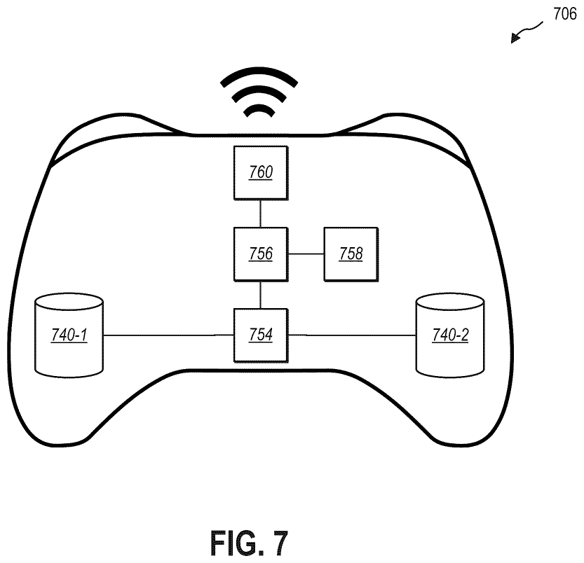

FIG. 7 is a schematic diagram of an embodiment of an electronic device controller 700, according to some embodiments of the present disclosure. In some embodiments, an electronic device controller 700 includes at least one haptic device 740-1 and a haptic controller 754 in communication with the haptic device 740-1. In some examples, a haptic controller 754 is in electrical communication with a plurality of haptic devices 740-1, 740-2. In some examples, each haptic device 740-1, 740-2 has a dedicated haptic controller. In some examples, at least one haptic device 740-1, 740-2 of the electronic device controller 700 has a dedicated haptic controller.

In some embodiments, the electronic device controller includes a processor 756 in communication with the haptic controller(s) 754. In some examples, the processor 756 is a general-use processor. In some examples, the processor 756 is a system on chip or application specific integrated circuit. In some examples, a haptic controller 754 is integrated with the processor 756 (such as in a system on chip or application specific integrated circuit).

The processor 756 is further in communication with a hardware storage device 758 having instructions stored thereon that, when executed by the processor, cause the electronic device controller to perform at least part of any method described herein. In some embodiments, the hardware storage device 758 is a non-transient storage device including any of RAM, ROM, EEPROM, magnetic disk storage or other magnetic storage devices, or any other medium which can be used to store desired program code means in the form of computer-executable instructions or data structures and which can be accessed by a general purpose or special purpose processor.

In some embodiments, the processor 756 is further in communication with a communication device 760. In some examples, the communication device 760 is a wired communication device that allows communication between the electronic device controller and an electronic device via a wired connection. In some examples, the communication device 760 is a wireless communication device that allows communication between the electronic device controller and an electronic device via a wireless connection. In some embodiments, the communication device 760 communicates directly with the electronic device, such as via a local radio frequency (RF) communication with an antenna of the electronic device. In some embodiments, the communication device 760 communicates indirectly with the electronic device or machine, such as via a local RF communication with an access point to a network to communication with an electronic device, such as for cloud processing.

As described herein, the hardware storage device 758 of the electronic device controller 700 has instructions stored thereon that cause the electronic device controller 700 to produce haptic feedback for a user according to haptic information received by the electronic device controller 700.

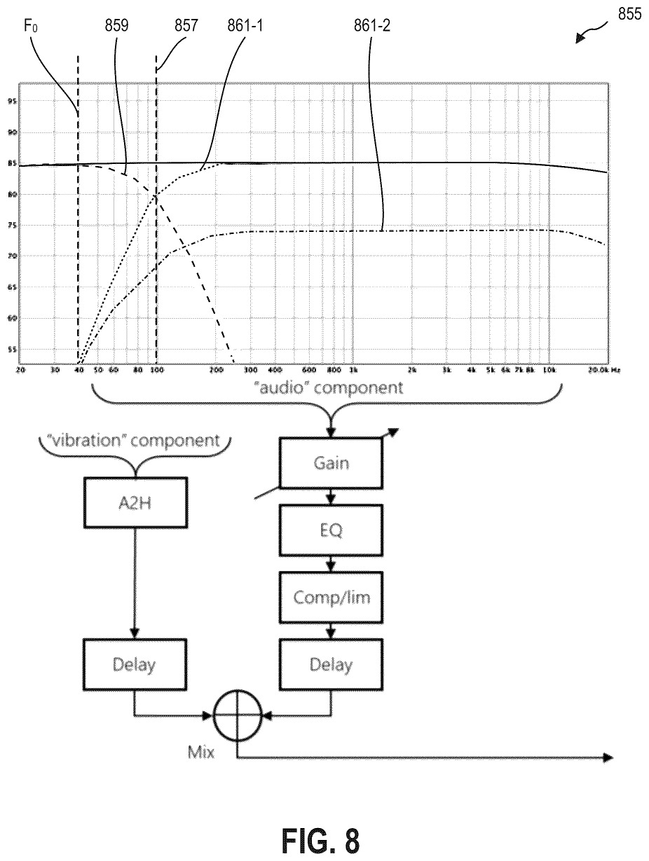

FIG. 8 is a diagram of a crossover network 855 including a crossover value 857 between a vibration information 859 portion and an audio information 861-1 portion. In some embodiments, the vibration information 859 includes portions of the provided haptic waveform from 0 Hz to the crossover value 857. In some embodiments, the audio information 861-1 includes portions of the provided haptic waveform greater than the crossover value 857. In some embodiments, the audio information 861-1 is between the crossover value and 4.0 kHz. In some embodiments, the audio information 861-1 is between the crossover value and 8.0 kHz. For example, the provided haptic waveform may have a maximum frequency of 8.0 kHz and the sampling duration of the Fourier transform produces audio information 861-1 in the crossover network 855 with a maximum frequency of 4.0 kHz.

The vibration information 859 reproduces the relatively low frequency portions of the provided haptic waveform. The low frequency vibrations are tactilely recognizable by the user through their hands or other parts of the body, while the user's hands or body is not sufficiently sensitive to detect the higher frequency vibrations tactilely. The audio information 861-1 reproduces the relatively high frequency portions of the provided haptic waveform that are audible to the user. In some embodiments, the accessory device includes the linear haptic device positioned in a housing or against a housing wall that provides a resonance chamber to increase the audible sounds of the linear haptic device.

In some embodiments, a linear haptic device has a resonant frequency (F₀) in the vibration information 859 portion of the frequency spectrum. For example, a linear haptic device is primarily intended to create tactilely discernable vibrations, and many linear haptic devices are therefore designed with a resonant frequency below 100 Hz. In some examples, the resonant frequency of the linear haptic device is 50 Hz, 75 Hz, or 100 Hz. The linear haptic device may be driven at or near the resonant frequency to conserved energy. In some embodiments, reproducing a portion of the haptic waveform at or near the resonant frequency consumes less energy than reproducing a portion of the haptic waveform at a higher frequency with an equivalent amplitude. In at least one embodiment, reproducing vibration information 859 of the haptic waveform at or near the resonant frequency consumes less energy than reproducing audio information 861-1 of the haptic waveform with an equivalent amplitude.

The accessory device and/or the haptic device may have a limit to the amount of power the haptic device can consume at any given time. In some embodiments, the accessory device (e.g., at the processor, at the haptic controller, at the haptic device) attenuates at least a portion of the audio information 861-1 in the provided haptic waveform and remixes the vibration information and attenuated audio information 861-2 into an output haptic waveform. The haptic controller then transmits a signal to the haptic device to drive the haptic device according to the output haptic waveform.

FIG. 8 illustrates an example of attenuated audio information 861-2 attenuated according to an attenuation value, such as a gain coefficient. In some embodiments, the attenuation value is constant for all frequencies of the audio information. For example, a 0.5 attenuation value causes the accessory device to remix the output haptic waveform with an amplitude of the audio information approximately 50% of the provided haptic waveform. In another example, a 0.75 attenuation value causes the accessory device to remix the output haptic waveform with an amplitude of the audio information approximately 75% of the provided haptic waveform.

In some embodiments, the attenuation value is proportional to the frequency of the audio information. For example, the attenuation value decreases (e.g., decreases the amplitude of the audio information) as the frequency increases. In at least one example, the attenuation value is 1.0 proximate the crossover value 857 and decreases away from the crossover value 857. In some embodiments, the attenuation value is linearly proportional to the frequency of the audio information 861-1, 861-2. For example, the attenuation value may decrease by 0.1 per 100 Hz. In some embodiments, the attenuation value is non-linearly proportional to the frequency of the audio information 861-1, 861-2. For example, the attenuation value may be exponentially proportional to the frequency.

In at least one embodiment, the attenuation value of the audio information 861-1, 861-2 is selected for various frequencies independently of a proportional relationship. For example, a plurality of attenuation values may be set by an equalizer (EQ). The EQ may allow the attenuation value (or gain) to be adjusted for different frequencies of the audio information 861-1, 861-2. In some embodiments, the EQ is in addition to and/or applied to the audio information 861-2 after the attenuation according to the attenuation value. In some embodiments, the EQ is in addition to and/or applied to the audio information 861-2 before the attenuation according to the attenuation value.

In some embodiments, an attenuation value is set for a portion of the audio information 861-1, 861-2 based on the electronic device controller or other electronic device including the haptic devices described herein. For example, an attenuation value may be based at least partially on the housing of the electronic device controller or other electronic device in or to which the haptic device is mounted. In at least one embodiment, the vibration produced by the haptic device between 2400 Hz and 2500 Hz results in an undesired resonance and/or rattle in the housing of an electronic device controller. As such, the attenuation value of the audio information 861-1, 861-2 in or near the range of 2400 Hz to 2500 Hz may be set to zero irrespectively of other proportional, coefficient, or EQ attenuation values of the audio information 861-1, 861-2 to prevent an undesired resonance and/or rattle in that range. In some embodiments, the attenuation value may be set to zero or near zero for a range of frequencies at the haptic controller or in the firmware to prevent reproduction of audio information in that range of frequencies irrespective of other considerations. Similar to a notch filter in with the amplitude is non-zero on either side of the intended frequency range, setting the attenuation value to zero or near zero in such a range can limit or prevent negative effects associated with the specific frequency range.

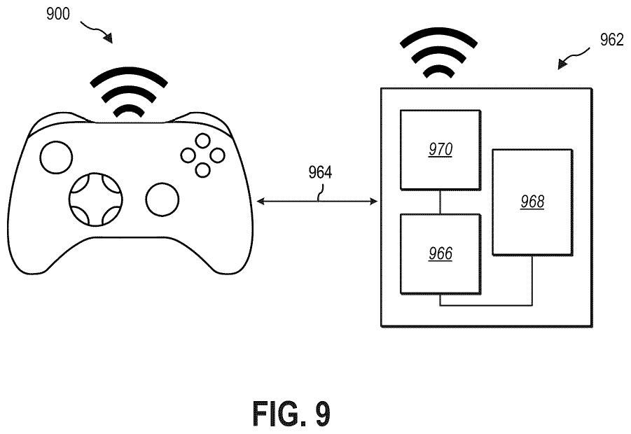

In some embodiments, EQ settings are obtained from user settings stored in a hardware storage device (e.g., hardware storage device 758 described in relation to FIG. 7) of the accessory device. In some embodiments, the EQ settings are obtained from the electronic device (e.g., video game console) in data communication with the accessory device (as will described in relation to FIG. 9). In some embodiments, the EQ settings are obtained from the interactive software application executed on the electronic device through an API. For example, a developer of the interactive software application may desire to consume more power from the accessory device to provide louder or higher frequency audio effects from the haptic device.

In some embodiments, the crossover value 857 is approximately 100 Hz. In some embodiments, the crossover value 857 is based on the accessory device (haptic controller, power supply, etc.) and a Device ID received from the accessory device and/or linear haptic device at an electronic device generating the output haptic waveform. In some embodiments, the crossover value 857 is based at least partially on a resonant frequency of the haptic device(s). In some examples, the crossover value 857 is proportional to the resonant frequency of the haptic device, such as double the resonant frequency. In some examples, the crossover value 857 is set at a frequency greater than the resonant frequency such as by an offset (e.g., 50 Hz greater than the resonant frequency). In at least one embodiment, the crossover value 857 is obtained from the electronic device (e.g., video game console) in data communication with the accessory device (as will described in relation to FIG. 9). In some embodiments, the crossover value 857 is obtained from the interactive software application executed on the electronic device through an API. For example, a developer of the interactive software application may desire to consume more power from the accessory device to provide louder or higher frequency audio effects from the haptic device.

In some embodiments, a delay value is applied to one or both of the vibrational information and the attenuated audio information before remixing the vibrational information and the attenuated audio information. For example, the vibrational information delay and the audio information delay temporally align the vibrational information and the attenuated audio information when remixed. In at least one embodiment, the vibrational information is mapped to the resonant frequency and the vibrational information is changed based on resonant frequency. The processing time of changes to the vibrational information and/or the audio information can introduce differences in the necessary delay(s) to align the information during mixing.

In some embodiments, the remixed output haptic waveform is then provided to the haptic controller of the accessory device. In some embodiments, the remixed output haptic waveform is then provided to the linear haptic device. It should be understood that the output haptic waveform may include both the vibrational information and audio information which may not be discernable to all users tactilely, and the term “output haptic waveform” should not be understood to limit the frequency range of the waveform.

FIG. 9 is a system diagram of an embodiment of an electronic device controller 900 in communication with an electronic device 962 or other host device. In some embodiments, a system for providing haptic feedback to a user includes an electronic device controller 900 (such as described in relation to FIG. 7) containing at least one haptic device (such as described in relation to FIG. 4) and an electronic device 962 in data communication with the electronic device controller 900. In some embodiments, the electronic device 962 is a general-purpose computer. In some embodiments, the electronic device 962 is a specialized computing device, such as a retail commodity video game console. In some embodiments, the electronic device 962 is a server computer or part of a server blade that is located remotely to the electronic device controller. In some embodiments, the electronic device is a computing device in a machine or other system. In such examples, the electronic device controller is in data communication with the electronic device 962 via a network connection.

The electronic device 962 includes at least a processor 966, a hardware storage device 968, and a communication device 970. In some examples, the processor 966 is a general-use processor. In some examples, the processor 966 is a system on chip or application specific integrated circuit. In some examples, a haptic controller is integrated with the processor 966 (such as in a system on chip or application specific integrated circuit).

The processor 966 is further in communication with a hardware storage device 968 having instructions stored thereon that, when executed by the processor, cause the electronic device controller to perform at least part of any method described herein. In some embodiments, the hardware storage device 968 is a non-transient storage device including any of RAM, ROM, EEPROM, magnetic disk storage or other magnetic storage devices, or any other medium which can be used to store desired program code means in the form of computer-executable instructions or data structures and which can be accessed by a general purpose or special purpose processor.

In some embodiments, the processor 966 is further in communication with a communication device 970 that allows communication with the electronic device controller 900 by a data connection 964. In some examples, the communication device 970 is a wired communication device that allows communication between the electronic device 962 and an electronic device controller 900 via a wired connection. In some examples, the communication device 970 is a wireless communication device that allows communication between the electronic device 962 and an electronic device controller 900 via a wireless connection. In some embodiments, the communication device 970 communicates directly with the electronic device controller 900, such as via a local RF communication with an antenna of the electronic device controller 900. In some embodiments, the communication device 970 communicates indirectly with the electronic device controller 900, such as via a local RF communication with an access point to a network to communication with an electronic device controller 900, such as when the electronic device 962 is part of a cloud server.

In at least one embodiment, the electronic device 962 and the electronic device controller 900 transmit and receive a variety of information therebetween. For example, the electronic device 962 may transmit to the electronic device controller information including one or more of software audio, chat audio, game input protocol (GIP) commands, and other information, such as wake commands or other control information to manage data connection with the electronic device controller 900. In some embodiments, the provided haptic waveform is determined from software audio transmitted to the electronic device controller 900. In some embodiments, the provided haptic waveform is determined from software audio and subsequently transmitted to the electronic device controller 900. For example, some software, such as legacy or backward compatible electronic games, may lack explicit haptic information and/or lack haptic information to drive haptic devices, and support for haptic feedback to the user can be provided by mapping audio waveforms from the software audio to a haptic waveform.

In some embodiments, the haptic information received from the electronic device 962 is at least partially based on an application programming interface (API) provided to the interactive software application running on the electronic device 962. For example, the provided haptic waveform may have a waveform that changes based on a time step set by the API.

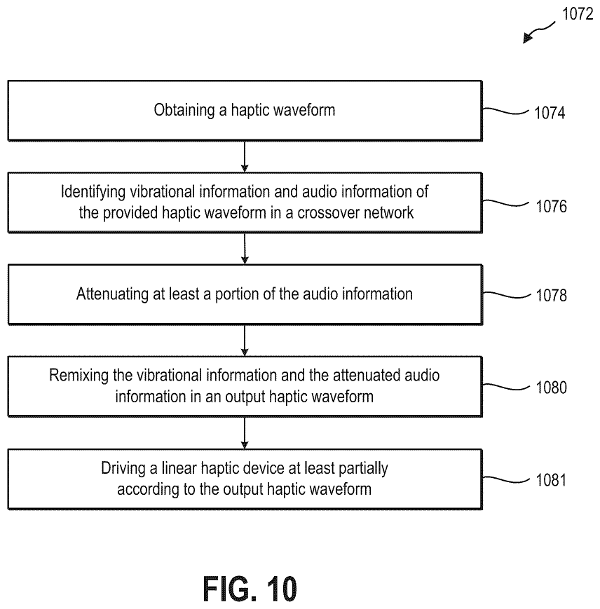

FIG. 10 is a flowchart illustrating an embodiment of a method 1072 of providing haptic feedback to a user. In some embodiments, the method 1072 includes obtaining a provided haptic waveform at 1074. In some embodiments, obtaining a provided haptic waveform includes sampling a haptic waveform based at least partially on a buffer duration. In some embodiments, the buffer duration is in a range having an upper value, a lower value, or upper and lower values including any of 10 ms, 20 ms, 30 ms, 50 ms, 100 ms, 200 ms, 500 ms, or other durations. In some examples, the buffer duration is greater than 10 ms. In some examples, the buffer duration is less than 500 ms. In some examples, the buffer duration is between 10 ms and 500 ms. In some examples, the buffer duration is between 25 ms and 250 ms. In at least one example, the buffer duration is about 50 ms. The longer the provided haptic waveform, the more precise the conversion is; however, a longer buffer duration increases a latency of the haptic feedback production.

In some embodiments, obtaining the haptic waveform includes obtaining the haptic waveform from an interactive software application. For example, the interactive software application may communicate with an operating system of an electronic device or with a haptic controller through an API provided by the electronic device or by an accessory device (such as an electronic device controller) in communication with the electronic device. In some embodiments, obtaining the provided haptic waveform includes determining the provided haptic waveform with the electronic device. In some embodiments, obtaining the provided haptic waveform includes receiving the provided haptic waveform from an electronic device at an accessory device, such as an electronic device controller.

In some embodiments, obtaining the provided haptic waveform includes determining a haptic waveform from software audio information. For example, the software audio information may be or include game audio of an interactive software application. In some examples, the software audio information may be or include a sound effect track of the game audio. In such examples, the background music may be excluded from the game audio to create a haptic waveform based on haptic events of the user's interaction with the interactive software application. In some examples, the software audio information may be or include a music track of the game audio. In such examples, the haptic information may be based at least partially on the music to reinforce the mood or ambience created by the music track in the interactive software application. In at least one example, at least a portion of the music may be reproduced through the linear haptic device as audio information.

In some embodiments, the software audio information has an audio waveform, or a portion of the software audio information is used to create an audio waveform. For example, the audio waveform may have an amplitude and a frequency and/or wavelength. In some embodiments, the amplitude of the audio waveform is scaled relative to an amplitude of the haptic device. For example, a maximum amplitude of the audio waveform may be scaled to be equal to a maximum amplitude of the haptic device. In some examples, the maximum amplitude of the audio waveform may be scaled to be equal to less than a maximum amplitude of the haptic device, such as 90%, 80%, or 50% of the maximum amplitude of the haptic device to limit wear on the haptic device. In some embodiments, the amplitude of the audio waveform may be scaled linearly to an amplitude of the haptic device. For example, an amplitude of the audio waveform that is 50% of the maximum amplitude of the audio waveform may be scaled to be 50% of the maximum amplitude of the haptic device. In some embodiments, the amplitude of the audio waveform may be scaled non-linearly to an amplitude of the haptic device. For example, an amplitude of the audio waveform that is 80% of the maximum amplitude of the audio waveform may be scaled to be 50% of the maximum amplitude of the haptic device to provide greater contrast in the haptic feedback based on the audio waveform.

In some embodiments, the method 1072 further includes identifying vibrational information and audio information of the provided haptic waveform in a crossover network at 1076, such as described in relation to FIG. 5-1 through FIG. 7. As described herein, in some embodiments, the frequency of various components of the provided haptic waveform may be determined via a Fourier transform. In some embodiments, the Fourier transform is a complete Fourier transform. In some embodiments, the Fourier transform is a discrete Fourier transform (DFT). In some embodiments, the Fourier transform is a fast Fourier transform (FFT). The Fourier transform converts the amplitude-versus-time waveform of the provided haptic waveform to an amplitude-versus-frequency waveform of the converted haptic waveform.

The provided haptic waveform can then be separated by frequency into the vibrational information and audio information based at least partially on a crossover value between the vibrational information and the audio information. The crossover value may be set or selected according to any of the techniques described herein. For example, the crossover value may be approximately 100 Hz. In some embodiments, the crossover value is based on the accessory device (haptic controller, power supply, etc.) and a Device ID received from the accessory device and/or linear haptic device at an electronic device generating the output haptic waveform. In some embodiments, the crossover value is based at least partially on a resonant frequency of the haptic device(s). In some examples, the crossover value is proportional to the resonant frequency of the haptic device, such as double the resonant frequency. In some examples, the crossover value is set at a frequency greater than the resonant frequency such as by an offset (e.g., 50 Hz greater than the resonant frequency). In at least one embodiment, the crossover value is obtained from the electronic device (e.g., video game console) in data communication with the accessory device. In some embodiments, the crossover value is obtained from the interactive software application executed on the electronic device through an API. For example, a developer of the interactive software application may desire to consume more power from the accessory device to provide louder or higher frequency audio effects from the haptic device.

The method 1072 further includes attenuating at least a portion of the audio information at 1078. In some embodiments, at least a portion of the audio information is attenuated based on an attenuation value. In some embodiments, the attenuation value is constant for all frequencies of the audio information. For example, a 0.5 attenuation value causes the accessory device to remix the output haptic waveform with an amplitude of the audio information approximately 50% of the provided haptic waveform. In another example, a 0.75 attenuation value causes the accessory device to remix the output haptic waveform with an amplitude of the audio information approximately 75% of the provided haptic waveform.

In some embodiments, the attenuation value is proportional to the frequency of the audio information. For example, the attenuation value decreases (e.g., decreases the amplitude of the audio information) as the frequency increases. In at least one example, the attenuation value is 1.0 proximate the crossover value and decreases away from the crossover value. In some embodiments, the attenuation value is linearly proportional to the frequency of the audio information. For example, the attenuation value may decrease by 0.1 per 100 Hz. In some embodiments, the attenuation value is non-linearly proportional to the frequency of the audio information. For example, the attenuation value may be exponentially proportional to the frequency.

In at least one embodiment, the attenuation value of the audio information is selected for various frequencies independently of a proportional relationship. For example, a plurality of attenuation values may be set by an equalizer (EQ). The EQ may allow the attenuation value (or gain) to be adjusted for different frequencies of the audio information. In some embodiments, the EQ is in addition to and/or applied to the audio information after the attenuation according to the attenuation value. In some embodiments, the EQ is in addition to and/or applied to the audio information before the attenuation according to the attenuation value.

In some embodiments, EQ settings are obtained from user settings stored in a hardware storage device (e.g., hardware storage device 758 described in relation to FIG. 7) of the accessory device. In some embodiments, the EQ settings are obtained from the electronic device (e.g., video game console) in data communication with the accessory device (as described in relation to FIG. 9). In some embodiments, the EQ settings are obtained from the interactive software application executed on the electronic device through an API. For example, a developer of the interactive software application may desire to consume more power from the accessory device to provide louder or higher frequency audio effects from the haptic device.

After attenuating a portion of the audio information, the method 1072 includes remixing the vibrational information and the attenuated audio information in an output haptic waveform at 1080 and driving a linear haptic device at least partially according to the output haptic waveform at 1081. In some embodiments, driving the haptic device or combination of haptic devices may be at least partially performed by a machine learning model (ML) model or system.

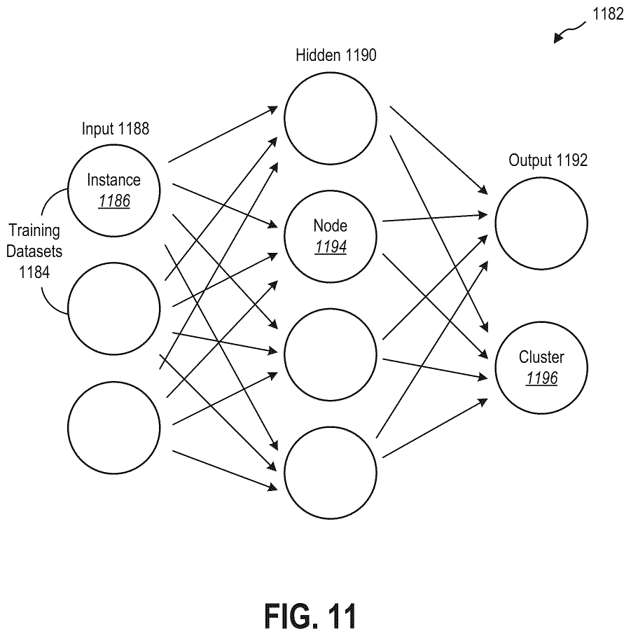

FIG. 11 is a flowchart of an embodiment of an ML model 1182 that may be used with any of the methods described herein. As used herein, a “machine learning model” refers to a computer algorithm or model (e.g., a classification model, a regression model, a language model, an object detection model) that can be tuned (e.g., trained) based on training input to approximate unknown functions. For example, an ML model may refer to a neural network or other machine learning algorithm or architecture that learns and approximates complex functions and generate outputs based on a plurality of inputs provided to the machine learning model. In some embodiments, an ML system, model, or neural network described herein is an artificial neural network. In some embodiments, an ML system, model, or neural network described herein is a convolutional neural network. In some embodiments, an ML system, model, or neural network described herein is a recurrent neural network. In at least one embodiment, an ML system, model, or neural network described herein is a Bayes classifier. As used herein, a “machine learning system” may refer to one or multiple ML models that cooperatively generate one or more outputs based on corresponding inputs. For example, an ML system may refer to any system architecture having multiple discrete ML components that consider different kinds of information or inputs.

As used herein, an “instance” refers to an input object that may be provided as an input to an ML system to use in generating an output, such as a provided haptic waveform, a converted haptic waveform, haptic information duration, haptic information frequency, haptic information response time, haptic information amplitude, haptic device resonant frequency, haptic device response time, haptic device maximum amplitude, audio waveform, haptic device resonant waveform, haptic device power consumption, or any other value or metric related to haptic feedback with the electronic device controller.

In some embodiments, the machine learning system has a plurality of layers with an input layer 1188 configured to receive at least one input training dataset 1184 or input training instance 1186 and an output layer 1192, with a plurality of additional or hidden layers 1190 therebetween. The training datasets can be input into the machine learning system to train the machine learning system and identify individual and combinations of labels or attributes of the training instances that allow the processor or haptic controller to improve haptic feedback performance and/or reduce power consumption of the haptic feedback devices.

In some embodiments, the machine learning system can receive multiple training datasets concurrently and learn from the different training datasets simultaneously.

In some embodiments, the machine learning system includes a plurality of machine learning models that operate together. Each of the machine learning models has a plurality of hidden layers between the input layer and the output layer. The hidden layers have a plurality of input nodes (e.g., nodes 1194), where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs, such as identified clusters 1196, to the output layer.

In some embodiments, each of the nodes 1194 has a linear function and an activation function. The linear function may attempt to optimize or approximate a solution with a line of best fit, such as reduced power cost or reduced latency. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs. In some embodiments, unsupervised learning can identify clusters of similar labels or characteristics for a variety of training instances and allow the machine learning system to extrapolate the performance of instances with similar characteristics.

In some embodiments, semi-supervised learning can combine benefits from supervised learning and unsupervised learning. As described herein, the machine learning system can identify associated labels or characteristic between instances, which may allow a training dataset with known outputs and a second training dataset including more general input information to be fused. Unsupervised training can allow the machine learning system to cluster the instances from the second training dataset without known outputs and associate the clusters with known outputs from the first training dataset.

### INDUSTRIAL APPLICABILITY

The present disclosure relates generally to systems and methods for providing haptic feedback to a user with a haptic device. More particularly, the haptic devices described herein are configured to provide haptic feedback to a user based on haptic information from a local computing device, remote computing system (cloud/internet), or a specialized video game console. In some embodiments, a haptic device according to the present disclosure is part of an electronic device controller that may be in data communication with an electronic device, such as a personal computer, cloud service, or video game console. In some embodiments, an electronic device controller is in data communication via a wired data connection. In other embodiments, the electronic device controller is in wireless data communication. In some embodiments, a haptic device, according to the present disclosure, is part of another electronic device, such as an article of furniture, a wearable device, or another electronic device that is not a controller.

In some embodiments, a haptic device, according to the present disclosure, is a linear haptic device. For example, a linear haptic device is any haptic device configured to accelerate a mass in a linear motion. The linear haptic device may oscillate the mass within a housing to create a shaking sensation. The linear haptic device may accelerate the mass once to create a click sensation. In some examples, a linear haptic device includes any of a linear resonant actuator (LRA), voice coil actuator (VCA), piezo electric actuators (PEA), and other electromagnetic actuators or motor that accelerate a mass with a linear acceleration. The duration, amplitude, and frequency of the waveform produced by the acceleration and/or oscillation of the mass in the haptic device can simulate or suggest a variety of haptic feedbacks to a user.

In some embodiments, the haptic device is used to simulate a haptic event, such as an in-software event, experience, action, or object. For example, the electronic device controller may be a user input device to a computing device or electronic gaming console. The computing device or electronic gaming console may have an interactive software application stored thereon that, when executed by the computing device or electronic gaming console, simulates a virtual environment with which the user can interact. When an avatar or other user-proxy interacts with the virtual environment, haptic feedback through the electronic device controller may convey that haptic event to the user. While the present disclosure will primarily reference virtual environments, in other examples, the electronic device controller may be a user input device to a machine or other device that moves and interacts with the physical environment. The electronic device controller may control or operate at least a portion of the machine, and when the machine interacts with the physical environment, haptic feedback through the electronic device controller may convey that haptic event to the user. In other examples, the haptic device is part of another device, such as an article of furniture that provides haptic feedback to the user.

In some embodiments, a haptic device, according to the present disclosure, is an eccentric rotating mass (ERM) haptic device. For example, the ERM haptic device has a motor that rotates a rotationally imbalanced mass around a rotational axis to create a vibration at a frequency based at least partially rotational frequency. In some examples, the motor of the ERM haptic device rotates the mass at an angular velocity and frequency based at least partially on a voltage applied to the motor.

In a particular example, the electronic device controller may allow the user to operate a power drill (either virtual or physical). In some embodiments, the haptic device may simulate the haptic event of the vibrations of drilling into a plank of wood by recreating the haptic event via haptic devices at the same frequency, the same duration, the same amplitude, or combinations thereof. For example, a drill may vibrate at a frequency of 100 Hertz (Hz) in the virtual environment, and the haptic device may recreate that haptic event with haptic feedback of 100 Hz at the haptic device. The frequency of the haptic event provides a recognizable sensation that, while hearing the drill and seeing a visualization of the drill on a display device, causes the user to perceive the haptic feedback through the electronic device as correlating to the haptic event displayed.

In some embodiments, the haptic device emits an audible vibration that recreates audio information in a provided haptic waveform. While the power drill of the above example vibrates at 100 Hz or less, a whine of an electric motor of the drill can be reproduced by the haptic device or a second haptic device at approximately 2000 Hz. In some embodiments, the higher frequency audio information reproduced by the haptic device is not perceptible to the user in a tactile manner, but the additional audio reproduction can increase immersion or provide an additional channel of audio for a software developer.

In some examples, the electronic device (a computing device, a physical machine, or other device) that generates the haptic event may provide a haptic waveform to be replicated at the haptic device. In some embodiments, the haptic waveform is intended for a linear haptic device and includes a plurality of overlaid sinusoidal waveforms that combine to create the provided haptic waveform. In such embodiments, the haptic waveform is replicable by the response rate of a linear haptic device.

In some embodiments, systems and methods according to the present disclosure convert the provided haptic waveform to one or more frequency peaks, which can be individually remixed into a remixed haptic waveform for reproduction at one or more haptic devices. In some embodiments, a crossover network separates a provided haptic waveform into vibrational information and audio information based at least partially on a crossover value between the vibrational information and audio information portions of the provided haptic waveform. In some embodiments, the vibrational information of the provided haptic waveform is reproduced at or near a resonant frequency of the haptic device, conserving electrical power in the accessory device. In some embodiments, the audio information of the provided haptic waveform is attenuated or otherwise reduced in amplitude. For example, the audio information may be a higher frequency than the vibrational information and consume more power to reproduce with the haptic device than the vibrational information. Attenuating an amplitude of the audio information before producing the haptic feedback can allow the haptic device to provide the intended haptic feedback of the vibrational information while remaining within power limitations of the accessory device and/or haptic device.

In some embodiments, a Fourier transform converts the provided haptic waveform from an amplitude-versus-time waveform into an amplitude-versus-frequency converted waveform. The frequency peaks in the converted waveform above a crossover value are identified as audio information, and the frequency peaks in the converted waveform below the crossover value are identified as vibrational information.

The audio information above the crossover value is attenuated to limit power consumption before the vibrational information and attenuated audio information are remixed into an output haptic waveform. In some embodiments, the output haptic waveform is used to drive a linear haptic device, a plurality of linear haptic devices, or a linear haptic device and an ERM haptic device.

In some embodiments, an electronic device controller includes a plurality of input buttons located on or in a body of the electronic device controller with at least one directional input device. The directional input devices may include one or more analog thumbsticks and/or one or more directional control pads. The input buttons may include face buttons, one or more menu or system buttons, shoulder buttons, trigger buttons, rear paddles, etc.

The thumbsticks and/or directional control pads may be used to control the movement of an avatar or cursor in a two-or three-dimensional virtual environment. The input buttons may be used to provide action commands (e.g., jump, crouch, defend, attack) to an avatar and/or interact with the environment. For example, a face button may be used to provide a jump command to an avatar in an adventure game application, while an analog trigger button may allow a user to precisely modulate a brake input for a racing game application.

The electronic device controller may include one or more haptic devices located in the body. In some embodiments, the haptic device imparts haptic feedback to the surface of the body, such as on a grip of the body 104, through which the user's palm may experience the haptic feedback. In some embodiments, haptic device imparts haptic feedback to a directional input device, such as a thumbstick, or to an input button, such as a trigger button. In at least one embodiment, a haptic device in or in communication with the trigger button may convey haptic events, such as changes in road surface during braking in the prior example. An electronic device controller may include a plurality of haptic devices in different locations, orientations, and configurations to provide a variety of haptic feedback to the user.

In some embodiments, an electronic device controller includes front grip regions, a main body region, shoulder regions, trigger regions, rear grip regions, other haptic regions, or combinations thereof. In some embodiments, an electronic device controller includes haptic devices in or in communication with directional input devices and/or input buttons, as described herein.

The haptic regions of the electronic device controller may provide haptic feedback to different regions of the user's hands and simulate or suggest different types of haptic events. For example, haptic feedback in the front grip regions may alternate between a left front grip region and a right front grip region to simulate or suggest footsteps in a virtual environment. Longer duration haptic feedback on the front grip regions may indicate footsteps from a larger entity or avatar, such as an elephant, in the virtual environment. In some examples, haptic feedback in the shoulder regions (located on the top edge of the body) may simulate or suggest rain falling on the user's avatar. In some examples, haptic feedback in the main body region may indicate a generalized or global haptic event, such as an explosion or earthquake in the virtual environment.

In some embodiments, different haptic devices are located in different haptic regions of the electronic device controller, such as different resonant frequencies, different amplitudes, different orientations, or different configurations between the haptic regions. In some embodiments, the electronic device controller includes an ERM haptic device. In some embodiments, the electronic device controller includes a linear haptic device. In some embodiments, the electronic device controller includes a plurality of haptic devices. In some embodiments, the electronic device controller includes a plurality of haptic devices that includes at least one ERM haptic device and at least one linear haptic device.

A linear haptic device may have a resonant frequency at which the linear haptic device is most efficient. Replication of high amplitude waveforms with a frequency at or near the resonant frequency may be the most power efficient haptic feedback the linear haptic device can produce. The linear haptic device moves a mass to generate impulses that provide the haptic feedback. In some embodiments, an electromagnet generates a magnetic field in a bore of the linear haptic device. The mass experiences a magnetic force in response to the presence of the magnetic field accelerating the mass in a first direction in the bore.

The electromagnet may then change a direction of the magnetic field and apply a magnetic force in the opposite direction. In some embodiments, the mass reaching a first end of the electromagnet before slowing and stopping proximate the first end due to a restoring force. In some embodiments, a magnetic biasing element, such as a permanent magnet, applies the restoring force. In some embodiments, a mechanical biasing element, such as a spring or a bushing, applies the restoring force. After stopping proximate the first end, the mass, in some embodiments, accelerates away from the first end toward a center of the bore.

In some embodiments, the mass moves through the bore toward a second end of the bore. By oscillating through the bore, the mass shakes the linear haptic device to create haptic feedback in response to an applied electric current in the direction of the oscillating mass. The magnetic field generated by the electromagnet may determine the speed, frequency, and amplitude of the oscillations through the linear haptic device.

In some embodiments, an ERM haptic device provides low frequency, slow response haptics. The ERM haptic device includes a motor configured to rotate a driveshaft. The driveshaft is rotationally fixed to a mass. The rotating mass is off-center from the rotational axis of the driveshaft.

ERM haptic devices produce an uneven centripetal force which causes the ERM haptic device to move in a lateral direction relative to the rotational axis of the driveshaft. This movement also produces associated lateral vibrations. ERM haptic devices typically contain a larger mass than a linear haptic device, which allows for more powerful haptic feedback, but with lower frequency and with slower latency. In contrast, linear haptic devices can allow for rapid changes to amplitude that can modulate the haptic feedback and/or start and stop the haptic feedback faster than an ERM. In some embodiments, an ERM haptic device can be used in conjunction with a linear haptic device to provide a combination of powerful and advanced haptic feedback.

The provided haptic waveform is, in some embodiments, non-sinusoidal with a plurality of frequencies present in the provided haptic waveform. The shorter latency of a linear haptic device may allow the linear haptic device to replicate the provided haptic waveform, while the longer latency of an ERM haptic device allows the ERM haptic device to replicate the primary or secondary vibrational frequencies of the provided haptic waveform.

In some embodiments, the provided haptic waveform is converted to a converted waveform by a Fourier transform. In some embodiments, the Fourier transform is a complete Fourier transform. In some embodiments, the Fourier transform is a discrete Fourier transform (DFT). In some embodiments, the Fourier transform is a fast Fourier transform (FFT). The Fourier transform converts the amplitude-versus-time waveform of the provided haptic waveform to an amplitude-versus-frequency waveform of the converted haptic waveform.

The converted haptic waveform decomposes the provided haptic waveform to a set of sinusoidal waveforms that are represented at frequency peaks within the converted haptic waveform. The higher the amplitude of the frequency peak, the greater the amplitude of the associated sinusoidal wave component of the provided haptic waveform. The converted haptic waveform can, thereby, decompose the provided haptic waveform into the portions (e.g., constituent sinusoidal waveforms) with frequencies above a crossover value and below the crossover value in a crossover network.

The precision with which a frequency peak can be determined, however, is relative to the width of a frequency bin of the converted haptic waveform. The width of the frequency bin is related to the sample length of the provided haptic waveform. In some embodiments, systems and methods according to the present disclosure sample the provided haptic waveform based at least partially on a buffer duration. In some embodiments, the buffer duration is in a range having an upper value, a lower value, or upper and lower values including any of 10 milliseconds (ms), 20 ms, 30 ms, 50 ms, 100 ms, 200 ms, 500 ms, or other durations.

As described above, in some embodiments, the provided haptic waveform 646 is provided from the electronic device based on an expected linear haptic device. For example, the developer of an interactive software application (e.g., a video game) for the electronic device (e.g., video game console) may provide, through an API, the provided haptic waveform 646 based on the linear haptic device provided in an electronic game controller that is common for or standard with that electronic device. linear haptic device has an inherent resonant frequency (F₀) of the mass in the linear haptic device based upon the properties of the mass, magnet(s), materials, other components, manufacturing tolerances, etc. A single linear haptic device may exhibit variations in the natural resonant frequency based at least partially on age or wear of the linear haptic device, temperature of the linear haptic device, orientation of the linear haptic device, etc. In some embodiments, systems and methods according to the present disclosure calculate or measure the dynamic resonant frequency of the haptic device to adapt the drive frequency of the magnetic field to the dynamic resonant frequency.

A linear haptic device, such as an LRA or VCA, has a natural resonant frequency at which the harmonics of the linear haptic device allow the linear haptic device to continue oscillating with the least input energy. For example, an impulse that is timed at the natural resonant frequency of the mass through the bore of the linear haptic device accelerates the mass through bore with the energy loss. Similar to a pendulum motion, the mass experiences a restoring force that urges the mass back toward the center of the bore. The impulse applied to the mass can maintain or change the amplitude of the oscillation of the mass.

In some embodiments, an output haptic waveform is output by a haptics controller to the haptic device as a series of electrical signals to control the electromagnet of the linear haptic device. The output haptic waveform is generated at the linear haptic device by providing input energy to a mass via the magnetic field generated in response to the electrical signals. By applying a magnetic force to the mass at the resonant frequency in alternating directions as the mass oscillates, the mass is moved with the least input energy and least power consumption. More specifically, some embodiments apply the magnetic force while the mass is near the center of the bore and while the net restoring force (i.e., that applied near either end of the bore) is approximately zero. As the restoring force may be a permanent magnet or a mechanical biasing element, the restoring force of the linear haptic device requires little or no input energy. To cause the mass to oscillate at a frequency other than the resonant frequency, additional input energy is needed to overcome or add to the restoring force.

Oscillations at or near the resonant frequency, therefore, can produce large vibration amplitudes with comparatively less input energy, while other frequencies (such as audio information at higher frequencies) can require greater input energy. In some embodiments, as will be described more herein, a crossover value of the crossover network for the haptic waveform is selected at least partially based on the resonant frequency of the linear haptic device.

In some embodiments, the provided haptic waveform is provided and/or selected at least partially based on the resonant frequency of the expected linear haptic device. When the provided haptic waveform is converted to a converted haptic waveform by a Fourier transform, the resonant frequency of the expected linear haptic device may manifest as a frequency peak. However, the unique haptic information of the provided haptic waveform may be presented in the other frequency peaks, and some embodiments of systems and methods according to the present disclosure discount, reduce, or ignore the frequency peak at the resonant frequency of the expected linear haptic device as that frequency peak may be present in some, most, or all of the provided haptic waveforms intended for the expected linear haptic device.

In some embodiments, an electronic device controller includes at least one haptic device and a haptic controller in communication with the haptic device. In some examples, a haptic controller is in electrical communication with a plurality of haptic devices. In some examples, each haptic device has a dedicated haptic controller. In some examples, at least one haptic device of the electronic device controller has a dedicated haptic controller.

In some embodiments, the electronic device controller includes a processor in communication with the haptic controller(s). In some examples, the processor is a general-use processor. In some examples, the processor is a system on chip or application specific integrated circuit. In some examples, a haptic controller is integrated with the processor (such as in a system on chip or application specific integrated circuit).

The processor is further in communication with a hardware storage device having instructions stored thereon that, when executed by the processor, cause the electronic device controller to perform at least part of any method described herein. In some embodiments, the hardware storage device is a non-transient storage device including any of RAM, ROM, EEPROM, magnetic disk storage or other magnetic storage devices, or any other medium which can be used to store desired program code means in the form of computer-executable instructions or data structures and which can be accessed by a general purpose or special purpose processor.

In some embodiments, the processor is further in communication with a communication device. In some examples, the communication device is a wired communication device that allows communication between the electronic device controller and an electronic device via a wired connection. In some examples, the communication device is a wireless communication device that allows communication between the electronic device controller and an electronic device via a wireless connection. In some embodiments, the communication device communicates directly with the electronic device, such as via a local radio frequency (RF) communication with an antenna of the electronic device. In some embodiments, the communication device communicates indirectly with the electronic device or machine, such as via a local RF communication with an access point to a network to communication with an electronic device, such as for cloud processing.

As described herein, the hardware storage device of the electronic device controller has instructions stored thereon that cause the electronic device controller to produce haptic feedback for a user according to haptic information received by the electronic device controller.

In some embodiments, a crossover network includes a crossover value between a vibration information portion and an audio information portion. In some embodiments, the vibration information includes portions of the provided haptic waveform from 0 Hz to the crossover value. In some embodiments, the audio information includes portions of the provided haptic waveform greater than the crossover value. In some embodiments, the audio information is between the crossover value and 4.0 kHz. In some embodiments, the audio information is between the crossover value and 8.0 kHz. For example, the provided haptic waveform may have a maximum frequency of 8.0 kHz and the sampling duration of the Fourier transform produces audio information in the crossover network with a maximum frequency of 4.0 KHz.

The vibration information reproduces the relatively low frequency portions of the provided haptic waveform. The low frequency vibrations are tactilely recognizable by the user through their hands or other parts of the body, while the user's hands or body is not sufficiently sensitive to detect the higher frequency vibrations tactilely. The audio information reproduces the relatively high frequency portions of the provided haptic waveform that are audible to the user. In some embodiments, the accessory device includes the linear haptic device positioned in a housing or against a housing wall that provides a resonance chamber to increase the audible sounds of the linear haptic device.

In some embodiments, a linear haptic device has a resonant frequency (F₀) in the vibration information portion of the frequency spectrum. For example, a linear haptic device is primarily intended to create tactilely discernable vibrations, and many linear haptic devices are therefore designed with a resonant frequency below 100 Hz. In some examples, the resonant frequency of the linear haptic device is 50 Hz, 75 Hz, or 100 Hz. The linear haptic device may be driven at or near the resonant frequency to conserved energy. In some embodiments, reproducing a portion of the haptic waveform at or near the resonant frequency consumes less energy than reproducing a portion of the haptic waveform at a higher frequency with an equivalent amplitude. In at least one embodiment, reproducing vibration information of the haptic waveform at or near the resonant frequency consumes less energy than reproducing audio information of the haptic waveform with an equivalent amplitude.

The accessory device and/or the haptic device may have a limit to the amount of power the haptic device can consume at any given time. In some embodiments, the accessory device (e.g., at the processor, at the haptic controller, at the haptic device) attenuates at least a portion of the audio information in the provided haptic waveform and remixes the vibration information and attenuated audio information into an output haptic waveform. The haptic controller then transmits a signal to the haptic device to drive the haptic device according to the output haptic waveform.

In some embodiments, an attenuation value, such as a gain coefficient, is constant for all frequencies of the audio information. For example, a 0.5 attenuation value causes the accessory device to remix the output haptic waveform with an amplitude of the audio information approximately 50% of the provided haptic waveform. In another example, a 0.75 attenuation value causes the accessory device to remix the output haptic waveform with an amplitude of the audio information approximately 75% of the provided haptic waveform.

In some embodiments, the attenuation value is proportional to the frequency of the audio information. For example, the attenuation value decreases (e.g., decreases the amplitude of the audio information) as the frequency increases. In at least one example, the attenuation value is 1.0 proximate the crossover value and decreases away from the crossover value. In some embodiments, the attenuation value is linearly proportional to the frequency of the audio information. For example, the attenuation value may decrease by 0.1 per 100 Hz. In some embodiments, the attenuation value is non-linearly proportional to the frequency of the audio information. For example, the attenuation value may be exponentially proportional to the frequency.

In at least one embodiment, the attenuation value of the audio information is selected for various frequencies independently of a proportional relationship. For example, a plurality of attenuation values may be set by an equalizer (EQ). The EQ may allow the attenuation value (or gain) to be adjusted for different frequencies of the audio information. In some embodiments, the EQ is in addition to and/or applied to the audio information after the attenuation according to the attenuation value. In some embodiments, the EQ is in addition to and/or applied to the audio information before the attenuation according to the attenuation value.

In some embodiments, an attenuation value is set for a portion of the audio information based on the electronic device controller or other electronic device including the haptic devices described herein. For example, an attenuation value may be based at least partially on the housing of the electronic device controller or other electronic device in or to which the haptic device is mounted. In at least one embodiment, the vibration produced by the haptic device between 2400 Hz and 2500 Hz results in an undesired resonance and/or rattle in the housing of an electronic device controller. As such, the attenuation value of the audio information in or near the range of 2400 Hz to 2500 Hz may be set to zero irrespectively of other proportional, coefficient, or EQ attenuation values of the audio information to prevent an undesired resonance and/or rattle in that range. In some embodiments, the attenuation value may be set to zero or near zero for a range of frequencies at the haptic controller or in the firmware to prevent reproduction of audio information in that range of frequencies irrespective of other considerations. Similar to a notch filter in with the amplitude is non-zero on either side of the intended frequency range, setting the attenuation value to zero or near zero in such a range can limit or prevent negative effects associated with the specific frequency range.

In some embodiments, EQ settings are obtained from user settings stored in a hardware storage device of the accessory device. In some embodiments, the EQ settings are obtained from the electronic device (e.g., video game console) in data communication with the accessory device. In some embodiments, the EQ settings are obtained from the interactive software application executed on the electronic device through an API. For example, a developer of the interactive software application may desire to consume more power from the accessory device to provide louder or higher frequency audio effects from the haptic device.

In some embodiments, the crossover value is approximately 100 Hz. In some embodiments, the crossover value is based on the accessory device (haptic controller, power supply, etc.) and a Device ID received from the accessory device and/or linear haptic device at an electronic device generating the output haptic waveform. In some embodiments, the crossover value is based at least partially on a resonant frequency of the haptic device(s). In some examples, the crossover value is proportional to the resonant frequency of the haptic device, such as double the resonant frequency. In some examples, the crossover value is set at a frequency greater than the resonant frequency such as by an offset (e.g., 50 Hz greater than the resonant frequency). In at least one embodiment, the crossover value is obtained from the electronic device (e.g., video game console) in data communication with the accessory device. In some embodiments, the crossover value is obtained from the interactive software application executed on the electronic device through an API. For example, a developer of the interactive software application may desire to consume more power from the accessory device to provide louder or higher frequency audio effects from the haptic device.

In some embodiments, a delay value is applied to one or both of the vibrational information and the attenuated audio information before remixing the vibrational information and the attenuated audio information. For example, the vibrational information delay and the audio information delay temporally align the vibrational information and the attenuated audio information when remixed. In at least one embodiment, the vibrational information is mapped to the resonant frequency and the vibrational information is changed based on resonant frequency. The processing time of changes to the vibrational information and/or the audio information can introduce differences in the necessary delay(s) to align the information during mixing.

In some embodiments, the remixed output haptic waveform is then provided to the haptic controller of the accessory device. In some embodiments, the remixed output haptic waveform is then provided to the linear haptic device. It should be understood that the output haptic waveform may include both the vibrational information and audio information which may not be discernable to all users tactilely, and the term “output haptic waveform” should not be understood to limit the frequency range of the waveform.

In some embodiments, an electronic device controller is in communication with an electronic device or other host device. In some embodiments, a system for providing haptic feedback to a user includes an electronic device controller containing at least one haptic device and an electronic device in data communication with the electronic device controller. In some embodiments, the electronic device is a general-purpose computer. In some embodiments, the electronic device is a specialized computing device, such as a retail commodity video game console. In some embodiments, the electronic device is a server computer or part of a server blade that is located remotely to the electronic device controller. In some embodiments, the electronic device is a computing device in a machine or other system. In such examples, the electronic device controller is in data communication with the electronic device via a network connection.

The electronic device includes at least a processor, a hardware storage device, and a communication device. In some examples, the processor is a general-use processor. In some examples, the processor is a system on chip or application specific integrated circuit. In some examples, a haptic controller is integrated with the processor (such as in a system on chip or application specific integrated circuit).

The processor is further in communication with a hardware storage device having instructions stored thereon that, when executed by the processor, cause the electronic device controller to perform at least part of any method described herein. In some embodiments, the hardware storage device is a non-transient storage device including any of RAM, ROM, EEPROM, magnetic disk storage or other magnetic storage devices, or any other medium which can be used to store desired program code means in the form of computer-executable instructions or data structures and which can be accessed by a general purpose or special purpose processor.

In some embodiments, the processor is further in communication with a communication device that allows communication with the electronic device controller by a data connection. In some examples, the communication device is a wired communication device that allows communication between the electronic device and an electronic device controller via a wired connection. In some examples, the communication device is a wireless communication device that allows communication between the electronic device and an electronic device controller via a wireless connection. In some embodiments, the communication device communicates directly with the electronic device controller, such as via a local RF communication with an antenna of the electronic device controller. In some embodiments, the communication device communicates indirectly with the electronic device controller, such as via a local RF communication with an access point to a network to communication with an electronic device controller, such as when the electronic device is part of a cloud server.

In at least one embodiment, the electronic device and the electronic device controller transmit and receive a variety of information therebetween. For example, the electronic device may transmit to the electronic device controller information including one or more of software audio, chat audio, game input protocol (GIP) commands, and other information, such as wake commands or other control information to manage data connection with the electronic device controller. In some embodiments, the provided haptic waveform is determined from software audio transmitted to the electronic device controller. In some embodiments, the provided haptic waveform is determined from software audio and subsequently transmitted to the electronic device controller. For example, some software, such as legacy or backward compatible electronic games, may lack explicit haptic information and/or lack haptic information to drive haptic devices, and support for haptic feedback to the user can be provided by mapping audio waveforms from the software audio to a haptic waveform.

In some embodiments, the haptic information received from the electronic device is at least partially based on an application programming interface (API) provided to the interactive software application running on the electronic device. For example, the provided haptic waveform may have a waveform that changes based on a time step set by the API.

In some embodiments, a method of providing haptic feedback to a user includes obtaining a provided haptic waveform. In some embodiments, obtaining a provided haptic waveform includes sampling a haptic waveform based at least partially on a buffer duration. In some embodiments, the buffer duration is in a range having an upper value, a lower value, or upper and lower values including any of 10 ms, 20 ms, 30 ms, 50 ms, 100 ms, 200 ms, 500 ms, or other durations. In some examples, the buffer duration is greater than 10 ms. In some examples, the buffer duration is less than 500 ms. In some examples, the buffer duration is between 10 ms and 500 ms. In some examples, the buffer duration is between 25 ms and 250 ms. In at least one example, the buffer duration is about 50 ms. The longer the provided haptic waveform, the more precise the conversion is; however, a longer buffer duration increases a latency of the haptic feedback production.

In some embodiments, obtaining the haptic waveform includes obtaining the haptic waveform from an interactive software application. For example, the interactive software application may communicate with an operating system of an electronic device or with a haptic controller through an API provided by the electronic device or by an accessory device (such as an electronic device controller) in communication with the electronic device. In some embodiments, obtaining the provided haptic waveform includes determining the provided haptic waveform with the electronic device. In some embodiments, obtaining the provided haptic waveform includes receiving the provided haptic waveform from an electronic device at an accessory device, such as an electronic device controller.

In some embodiments, obtaining the provided haptic waveform includes determining a haptic waveform from software audio information. For example, the software audio information may be or include game audio of an interactive software application. In some examples, the software audio information may be or include a sound effect track of the game audio. In such examples, the background music may be excluded from the game audio to create a haptic waveform based on haptic events of the user's interaction with the interactive software application. In some examples, the software audio information may be or include a music track of the game audio. In such examples, the haptic information may be based at least partially on the music to reinforce the mood or ambience created by the music track in the interactive software application. In at least one example, at least a portion of the music may be reproduced through the linear haptic device as audio information.

In some embodiments, the software audio information has an audio waveform, or a portion of the software audio information is used to create an audio waveform. For example, the audio waveform may have an amplitude and a frequency and/or wavelength. In some embodiments, the amplitude of the audio waveform is scaled relative to an amplitude of the haptic device. For example, a maximum amplitude of the audio waveform may be scaled to be equal to a maximum amplitude of the haptic device. In some examples, the maximum amplitude of the audio waveform may be scaled to be equal to less than a maximum amplitude of the haptic device, such as 90%, 80%, or 50% of the maximum amplitude of the haptic device to limit wear on the haptic device. In some embodiments, the amplitude of the audio waveform may be scaled linearly to an amplitude of the haptic device. For example, an amplitude of the audio waveform that is 50% of the maximum amplitude of the audio waveform may be scaled to be 50% of the maximum amplitude of the haptic device. In some embodiments, the amplitude of the audio waveform may be scaled non-linearly to an amplitude of the haptic device. For example, an amplitude of the audio waveform that is 80% of the maximum amplitude of the audio waveform may be scaled to be 50% of the maximum amplitude of the haptic device to provide greater contrast in the haptic feedback based on the audio waveform.

In some embodiments, the method further includes identifying vibrational information and audio information of the provided haptic waveform in a crossover network, such as described in relation to FIG. 5-1 through FIG. 7. As described herein, in some embodiments, the frequency of various components of the provided haptic waveform may be determined via a Fourier transform. In some embodiments, the Fourier transform is a complete Fourier transform. In some embodiments, the Fourier transform is a discrete Fourier transform (DFT). In some embodiments, the Fourier transform is a fast Fourier transform (FFT). The Fourier transform converts the amplitude-versus-time waveform of the provided haptic waveform to an amplitude-versus-frequency waveform of the converted haptic waveform.

The provided haptic waveform can then be separated by frequency into the vibrational information and audio information based at least partially on a crossover value between the vibrational information and the audio information. The crossover value may be set or selected according to any of the techniques described herein. For example, the crossover value may be approximately 100 Hz. In some embodiments, the crossover value is based on the accessory device (haptic controller, power supply, etc.) and a Device ID received from the accessory device and/or linear haptic device at an electronic device generating the output haptic waveform. In some embodiments, the crossover value is based at least partially on a resonant frequency of the haptic device(s). In some examples, the crossover value is proportional to the resonant frequency of the haptic device, such as double the resonant frequency. In some examples, the crossover value is set at a frequency greater than the resonant frequency such as by an offset (e.g., 50 Hz greater than the resonant frequency). In at least one embodiment, the crossover value is obtained from the electronic device (e.g., video game console) in data communication with the accessory device. In some embodiments, the crossover value is obtained from the interactive software application executed on the electronic device through an API. For example, a developer of the interactive software application may desire to consume more power from the accessory device to provide louder or higher frequency audio effects from the haptic device.

The method further includes attenuating at least a portion of the audio information. In some embodiments, at least a portion of the audio information is attenuated based on an attenuation value. In some embodiments, the attenuation value is constant for all frequencies of the audio information. For example, a 0.5 attenuation value causes the accessory device to remix the output haptic waveform with an amplitude of the audio information approximately 50% of the provided haptic waveform. In another example, a 0.75 attenuation value causes the accessory device to remix the output haptic waveform with an amplitude of the audio information approximately 75% of the provided haptic waveform.

In some embodiments, the attenuation value is proportional to the frequency of the audio information. For example, the attenuation value decreases (e.g., decreases the amplitude of the audio information) as the frequency increases. In at least one example, the attenuation value is 1.0 proximate the crossover value and decreases away from the crossover value. In some embodiments, the attenuation value is linearly proportional to the frequency of the audio information. For example, the attenuation value may decrease by 0.1 per 100 Hz. In some embodiments, the attenuation value is non-linearly proportional to the frequency of the audio information. For example, the attenuation value may be exponentially proportional to the frequency.

In at least one embodiment, the attenuation value of the audio information is selected for various frequencies independently of a proportional relationship. For example, a plurality of attenuation values may be set by an equalizer (EQ). The EQ may allow the attenuation value (or gain) to be adjusted for different frequencies of the audio information. In some embodiments, the EQ is in addition to and/or applied to the audio information after the attenuation according to the attenuation value. In some embodiments, the EQ is in addition to and/or applied to the audio information before the attenuation according to the attenuation value.

In some embodiments, EQ settings are obtained from user settings stored in a hardware storage device of the accessory device. In some embodiments, the EQ settings are obtained from the electronic device (e.g., video game console) in data communication with the accessory device. In some embodiments, the EQ settings are obtained from the interactive software application executed on the electronic device through an API. For example, a developer of the interactive software application may desire to consume more power from the accessory device to provide louder or higher frequency audio effects from the haptic device.

After attenuating a portion of the audio information, the method includes remixing the vibrational information and the attenuated audio information in an output haptic waveform and driving a linear haptic device at least partially according to the output haptic waveform. In some embodiments, driving the haptic device or combination of haptic devices may be at least partially performed by a machine learning model (ML) model or system.

As used herein, a “machine learning model” refers to a computer algorithm or model (e.g., a classification model, a regression model, a language model, an object detection model) that can be tuned (e.g., trained) based on training input to approximate unknown functions. For example, an ML model may refer to a neural network or other machine learning algorithm or architecture that learns and approximates complex functions and generate outputs based on a plurality of inputs provided to the machine learning model. In some embodiments, an ML system, model, or neural network described herein is an artificial neural network. In some embodiments, an ML system, model, or neural network described herein is a convolutional neural network. In some embodiments, an ML system, model, or neural network described herein is a recurrent neural network. In at least one embodiment, an ML system, model, or neural network described herein is a Bayes classifier. As used herein, a “machine learning system” may refer to one or multiple ML models that cooperatively generate one or more outputs based on corresponding inputs. For example, an ML system may refer to any system architecture having multiple discrete ML components that consider different kinds of information or inputs.

As used herein, an “instance” refers to an input object that may be provided as an input to an ML system to use in generating an output, such as a provided haptic waveform, a converted haptic waveform, haptic information duration, haptic information frequency, haptic information response time, haptic information amplitude, haptic device resonant frequency, haptic device response time, haptic device maximum amplitude, audio waveform, haptic device resonant waveform, haptic device power consumption, or any other value or metric related to haptic feedback with the electronic device controller.

In some embodiments, the machine learning system has a plurality of layers with an input layer configured to receive at least one input training dataset or input training instance and an output layer, with a plurality of additional or hidden layers therebetween. The training datasets can be input into the machine learning system to train the machine learning system and identify individual and combinations of labels or attributes of the training instances that allow the processor or haptic controller to improve haptic feedback performance and/or reduce power consumption of the haptic feedback devices.

In some embodiments, the machine learning system can receive multiple training datasets concurrently and learn from the different training datasets simultaneously.

In some embodiments, the machine learning system includes a plurality of machine learning models that operate together. Each of the machine learning models has a plurality of hidden layers between the input layer and the output layer. The hidden layers have a plurality of input nodes (e.g., nodes), where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs, such as identified clusters, to the output layer.

In some embodiments, each of the nodes has a linear function and an activation function. The linear function may attempt to optimize or approximate a solution with a line of best fit, such as reduced power cost or reduced latency. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs. In some embodiments, unsupervised learning can identify clusters of similar labels or characteristics for a variety of training instances and allow the machine learning system to extrapolate the performance of instances with similar characteristics.

In some embodiments, semi-supervised learning can combine benefits from supervised learning and unsupervised learning. As described herein, the machine learning system can identify associated labels or characteristic between instances, which may allow a training dataset with known outputs and a second training dataset including more general input information to be fused. Unsupervised training can allow the machine learning system to cluster the instances from the second training dataset without known outputs and associate the clusters with known outputs from the first training dataset.

The present disclosure relates to systems and methods for providing haptic feedback to a user according to at least the examples provided in the sections below:

Clause 1. A method of providing haptic feedback to a user, the method comprising: obtaining a provided haptic waveform; identifying vibrational information of the provided haptic waveform in a crossover network; identifying audio information of the provided haptic waveform in the crossover network; attenuating at least a portion of the audio information to create attenuated audio information; remixing the vibrational information and the attenuated audio information in an output haptic waveform; and driving a linear haptic device at least partially according to the output haptic waveform.

Clause 2. The method of clause 1, wherein an attenuation value is at least partially proportional to a frequency value of the audio information.

Clause 3. The method of clause 1, wherein the provided haptic waveform is received from an interactive software application and an attenuation value is received from the interactive software application.

Clause 4. The method of clause 1, wherein attenuating at least a portion of the audio information includes at least a portion of the audio information based at least partially on an equalizer setting.

Clause 5. The method of clause 1, wherein an amplitude of the at least a portion of the audio information is set to zero.

Clause 6. The method of clause 1, wherein a crossover value between the vibrational information and the audio information of the crossover network is 100 Hz.

Clause 7. The method of clause 1, wherein the audio information has an upper value no more than 4000 Hz.

Clause 8. The method of clause 1, further comprising setting a crossover value before identifying the vibrational information and the audio information.

Clause 9. The method of clause 8, wherein setting the crossover value includes obtaining a resonant frequency of the linear haptic device.

Clause 10. The method of clause 8, wherein setting the crossover value includes obtaining a Device ID of a device including the linear haptic device.

Clause 11. The method of clause 1, further comprising delaying at least one of the vibrational information and the attenuated audio information before remixing.

Clause 12. A method of providing haptic feedback to a user, the method comprising: determining a provided haptic waveform from software audio information; identifying vibrational information of the provided haptic waveform in a crossover network; identifying audio information of the provided haptic waveform in the crossover network; attenuating at least a portion of the audio information to create attenuated audio information; remixing the vibrational information and the attenuated audio information in an output haptic waveform; and driving a linear haptic device at least partially according to the output haptic waveform.

Clause 13. The method of clause 12, further comprising delaying the audio information before remixing.

Clause 14. The method of clause 12, further comprising delaying the vibrational information before remixing.

Clause 15. The method of clause 12, wherein determining a provided haptic waveform from software audio information includes selectively excluding portions of the software audio information.

Clause 16. A device for providing haptic feedback to a user, the device comprising: a haptic controller; a linear haptic device; a processor; and a hardware storage device, the hardware storage device having instructions stored thereon that, when executed by the processor, cause the device to: obtain a provided haptic waveform; identify vibrational information of the provided haptic waveform in a crossover network; identify audio information of the provided haptic waveform in the crossover network; attenuate at least a portion of the audio information to create attenuated audio information; remix the vibrational information and the attenuated audio information in an output haptic waveform; and drive a linear haptic device at least partially according to the output haptic waveform.

Clause 17. The device of clause 16, wherein the instructions further cause the device to obtain the provided haptic waveform from a different electronic device.

Clause 18. The device of clause 16, wherein the instructions further cause the device to obtain the provided haptic waveform from audio information.

Clause 19. The device of clause 16, further comprising a communication device in data communication with the processor, wherein the communication device is configured to communicate with a host device.

Clause 20. The device of clause 16, wherein the device is an electronic game controller.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of providing haptic feedback to a user, the method comprising:
identifying vibrational information of a provided haptic waveform in a crossover network;
identifying audio information of the provided haptic waveform in the crossover network;
attenuating at least a portion of the audio information to create attenuated audio information;
remixing the vibrational information and the attenuated audio information in an output haptic waveform; and
driving a linear haptic device at least partially according to the output haptic waveform.

2. The method of claim 1, wherein an attenuation value is proportional to a frequency value of at least a portion of the audio information.

3. The method of claim 1, wherein the provided haptic waveform is received from an interactive software application and an attenuation value is received from the interactive software application.

4. The method of claim 1, wherein attenuating at least a portion of the audio information includes at least a portion of the audio information based at least partially on an equalizer setting.

5. The method of claim 1, wherein an amplitude of the at least a portion of the audio information is set to zero.

6. The method of claim 1, wherein a crossover value between the vibrational information and the audio information of the crossover network is 100 Hz.

7. The method of claim 1, wherein the audio information is between the crossover value and 4000 Hz.

8. The method of claim 1, further comprising setting a crossover value before identifying the vibrational information and the audio information.

9. The method of claim 8, wherein setting the crossover value includes obtaining a resonant frequency of the linear haptic device.

10. The method of claim 8, wherein setting the crossover value includes obtaining a Device ID of a device including the linear haptic device.

11. The method of claim 1, further comprising delaying at least one of the vibrational information and the attenuated audio information before remixing.

12. A method of providing haptic feedback to a user, the method comprising:
determining a provided haptic waveform from software audio information;
identifying vibrational information of the provided haptic waveform in a crossover network;
identifying audio information of the provided haptic waveform in the crossover network;
attenuating at least a portion of the audio information to create attenuated audio information;
remixing the vibrational information and the attenuated audio information in an output haptic waveform; and
driving a linear haptic device at least partially according to the output haptic waveform.

13. The method of claim 12, further comprising delaying the audio information before remixing.

14. The method of claim 12, further comprising delaying the vibrational information before remixing.

15. The method of claim 12, wherein determining a provided haptic waveform from software audio information includes selectively excluding portions of the software audio information.

16. A device for providing haptic feedback to a user, the device comprising:
a haptic controller;
a linear haptic device;
a processor; and
a hardware storage device, the hardware storage device having instructions stored thereon that, when executed by the processor, cause the device to:
identify vibrational information of a provided haptic waveform in a crossover network;
identify audio information of the provided haptic waveform in the crossover network;
attenuate at least a portion of the audio information to create attenuated audio information;
remix the vibrational information and the attenuated audio information in an output haptic waveform; and
drive a linear haptic device at least partially according to the output haptic waveform.

17. The device of claim 16, wherein the instructions further cause the device to obtain the provided haptic waveform from a different electronic device.

18. The device of claim 16, wherein the instructions further cause the device to obtain the provided haptic waveform from audio information.

19. The device of claim 16, further comprising a communication device in data communication with the processor, wherein the communication device is configured to communicate with a host device.

20. The device of claim 16, wherein the device is an electronic game controller.
